(19) United States
(12) Patent Application Publication
(10) Pub. No.: US 2009/0188059 A1
(43) Pub. Date: Jul. 30, 2009

(54) Pig with an Improved Seal Effect

(75) Inventors: Markus Albrecht, Abstatt (DE); Jan Reichler, Konstanz (DE)

Correspondence Address: FACTOR & LAKE, LTD, 1327 W. WASHINGTON BLVD., SUITE 5G/H, CHICAGO, IL, 60607, US

(73) Assignee: EISENMANN LACKTECHNICK GMBH & CO. KG, Boeblingen (DE)

(21) Appl. No.: 12/302,440

(22) PCT Filed: May 23, 2007
(86) PCT No.: PCT/EP07/04537

§ 371 Date: Nov. 25, 2008

(30) Foreign Application Priority Data
Jun. 1, 2006 (DE) 10 2006 025 546.1

(51) Int. Cl. F16L 55/38

(52) U.S. Cl. 15/104.061

(57) ABSTRACT

A pig for conveying a working medium inside a feed line comprises a pig body which can be driven inside the feed line by a pushing medium and which has on one front side a projection with a free front surface. The pig also contains at least one first and one second circumferential sealing element arranged on the pig body which are made of elastomeric material and which are at a distance from each other in the direction of the longitudinal axis of the pig body and which run coaxial to the longitudinal axis of the pig body. The sealing elements can be pressed against the inner wall of the feed line, in that the working medium or the pushing medium bears against a contact surface of the respective sealing element. The contact surface of the sealing element neighboring the front side with the projection is smaller than the contact surface of the other sealing element.

The invention relates to a pig for conveying a working medium within a supply line, with
a) a pig body which is capable of being driven within the supply line by a thrust medium and which exhibits at one end a projection with a free end face;
b) at least one first and one second circumferential sealing element arranged on the pig body and made of elastomeric material, which are spaced from one another in the direction of the longitudinal axis of the pig body and extend coaxially relative to the longitudinal axis of the pig body;
   whereby
c) the sealing elements are capable of being pressed against the inner wall of the supply line, by the working medium or the thrust medium exerting a force against a surface of application of the respective sealing element.

A pig of such a type is known, for example from EP 1 108 475 A2, and is used, for example, for the purpose of conveying lacquer within a supply line, ordinarily a tube. The latter may—for example in the case of a coating plant, in particular a lacquering plant—connect a paint reservoir to a pistol unit in a manner known as such. Use may also be made of such a pig in the course of cleaning appropriate supply lines with a suitable cleaning agent. A pig is frequently also employed in order to serve as a separating member between two liquid working media. A defined volume of lacquer can be transported between two pigs in the manner of a packet.

In the case of the aforementioned working medium it may accordingly be a question of, for example, lacquer or cleaning agent, which is present on one side of the pig within the supply line. Compressed air ordinarily serves as thrust medium, which is applied to the pig on the other side. However, a liquid medium may also serve as thrust medium.

By virtue of the application of the force of the compressed air on one side of the pig, the latter is moved towards the working medium which is present on the other side of the pig, whereby the two sealing elements offer a surface of application to the compressed air and to the working medium, respectively. On one side of the pig the compressed air accordingly exerts a force on the surface of application of the sealing element which is provided there, whereas on the other side of the pig a force is exerted on the surface of application of the sealing element by the working medium which offers a resistance to the movement of the pig. As a consequence of the forces exerted on their surfaces of application, both sealing elements are pressed against the inner wall of the supply line, the sealing elements being dimensioned in such a way that they are already applied to the inner wall of the supply line in sealing manner, even when the pig is not being moved therein. In the course of the propulsion of the pig within the supply line the sealing elements move along the inner wall thereof, as a result of which liquid working medium adhering to the inner wall is removed and pushed along in the direction of motion of the pig, ahead of the latter.

The projection at one end of the pig body reduces the probability that two pigs abutting with their projections stick together by virtue of lacquer residues which are present between them, since the pigs are able to touch one another only with a relatively small area. It is desirable to obtain this advantage. The known pigs are symmetrically formed with respect to their median plane, in order to be able to be employed bidirectionally. In particular, both sealing elements take the form of sealing lips of identical construction.

The object of the invention is to create a pig of the type stated in the introduction wherein the sealing effect is improved during the propulsion of the pig within the supply line.

This object in achieved in that
d) the surface of application of the sealing element that is adjacent to the end with the projection is smaller than the surface of application of the other sealing element.

In contrast with known pigs, in which the respective surface of application of the two sealing elements is equally large by reason of their identical construction, the sealing element having the larger surface of application—given the same force exerted on both sealing elements—is pressed against the inner wall of the supply line with higher pressure than the sealing element having the smaller surface of application. In this way, the sealing effect of the pig is enhanced overall during the propulsion thereof within the supply line.

At the same time, it is possible that the projection which reduces the risk of an agglutination of two pigs remains at one end of the pig body.

Advantageous further developments of the invention are specified in the dependent claims.

It is favourable if the first and second sealing elements take the form of first and second sealing lips with a radially outer sealing edge. In this way, a good scraping effect on the inner wall of the supply line is achieved.

From the point of view of production engineering, it is advantageous if the entire pig body, and not only the sealing elements, is formed from elastomeric material.

By way of elastomeric material, a hydrogenated nitrile rubber or a fluoroelastomer based on vinylidene-fluoride/hexafluoropropylene copolymers preferably enters into consideration, which are commercially—and consequently readily—available. A suitable fluoroelastomer is, for example, obtainable under the trade name Viton® from Du Pont Dow Elastomers L.L.C.

As far as the necessary flexibility is concerned, it is favourable if the elastomeric material exhibits a hardness of 65 to 100 Shore D. The elastomeric material preferably exhibits a hardness of 85 Shore D. In the case of hardness values within the stated ranges, there is a good compromise between a necessary flexibility/softness for a sufficient imperviousness and an acceptable abrasion of material.

If the free end face of the projection of the pig body is of convex design, the risk of an agglutination of two pigs that touch in each instance at this free end face is reduced still further, since the pigs are able to touch merely in punctiform manner. The sealing element adjacent to the projection on the pig body may, on the other hand, be formed in favourable manner if at the end with the projection the pig body exhibits an annular groove extending coaxially relative to the longitudinal axis of the pig body. Such an annular groove can be generated in the pig body in simple manner by turning.

The sealing element having the larger surface of application can be produced easily if at the end situated opposite the end with the projection the pig body exhibits a recess that is arranged centrally relative to the longitudinal axis of the pig body. In this case it is particularly advantageous if the recess is hemispherical.

In order to ensure a detection of the position of the pig with the aid of known sensor devices, it is advantageous if the pig is formed from a first part and from a second part connected thereto and contains a permanent magnet.

Alternatively, it is advantageous if the pig exhibits a closable blind bore which receives a permanent magnet. In this case it is favourable if the blind bore is closed with a stopper which is inserted into the blind bore in exactly fitting manner or is adhesion-bonded therein, the stopper being manufactured from the same material as the pig body.

As far as the blind bore is concerned, this is preferably provided on the side of the recess.

An exemplary embodiment of the invention will be elucidated in more detail below on the basis of the accompanying drawing. Shown in the latter are:

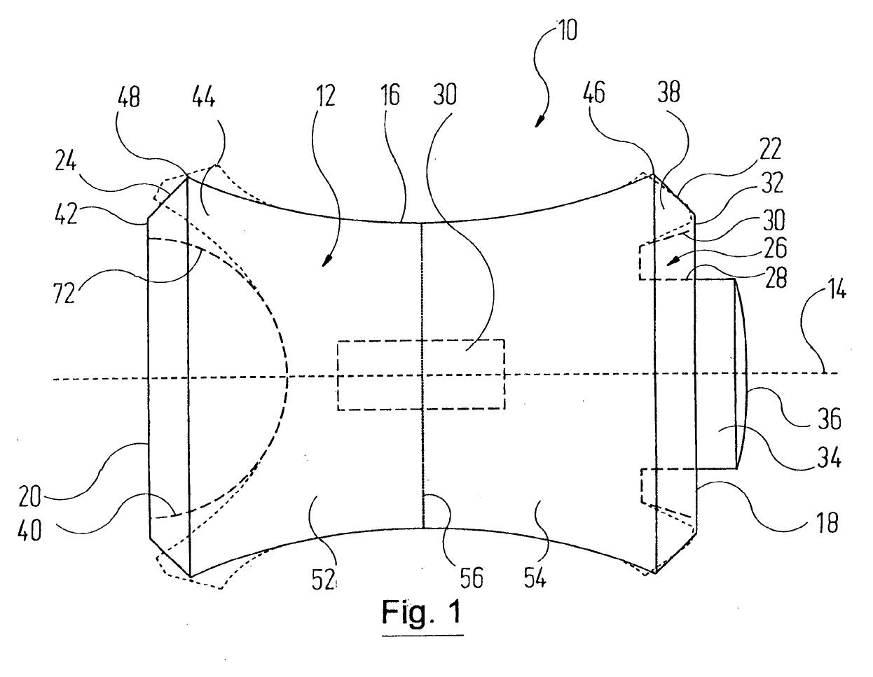

FIG. 1 a pig according to the invention;

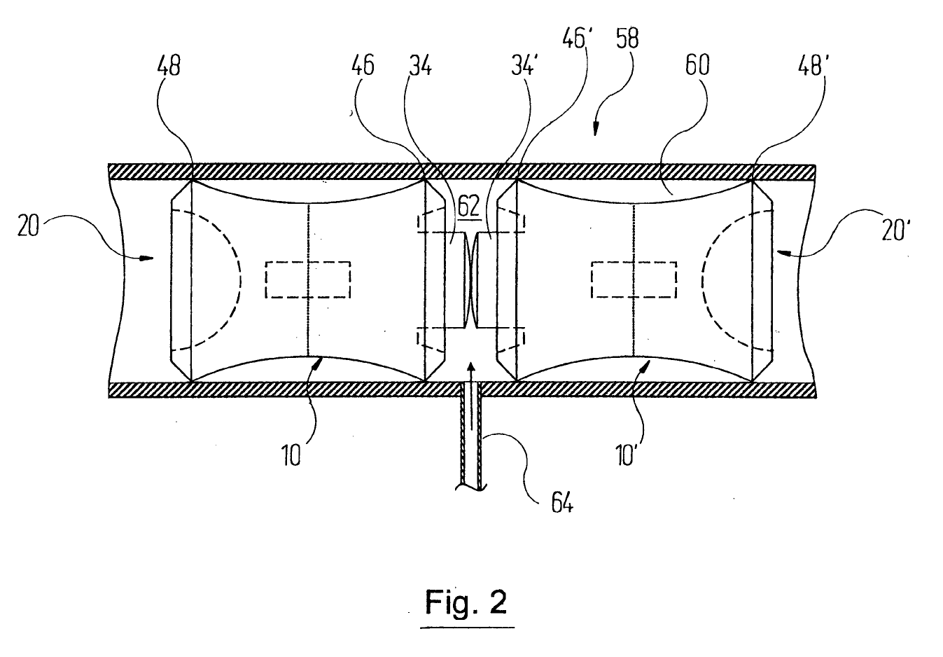

FIG. 2 two pigs according to FIG. 1 in a supply line within a pig station; and

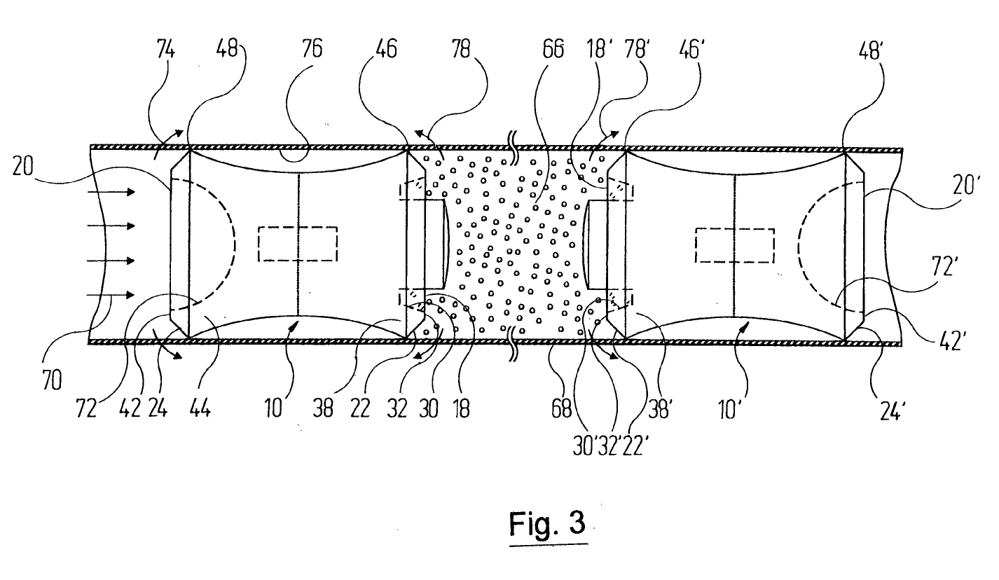

FIG. 3 two pigs according to FIG. 1 in a supply line, a working medium being located between the two pigs.

FIG. 1 shows a pig 10 with a pig body 12 which is formed in rotationally symmetrical manner relative to its longitudinal axis 14.

The pig body 12 exhibits a concave circumferential surface 16 and also, at both ends 18, 20, a radially outer chamfer 22 and 24, respectively.

The end 18 situated on the right in FIG. 1 is provided with an annular groove 26 which is coaxial relative to the longitudinal axis 14 of the pig body 12. The radially inner groove wall 28 of said annular groove extends parallel to the longitudinal axis 14 of the pig body 12, whereas the radially outer groove wall 30 in the direction towards end 18 is inclined outwards. Between the radially inner edge of the chamfer 22 and the annular groove 26 there remains a narrow annular surface 32, perpendicular to the longitudinal axis 14 of the pig body 12 and coaxial therewith. The inner groove wall 28 of the annular groove 26 continues outwards in the longitudinal direction of the pig body 12 into a circular cylindrical projection 34, the free end face 36 of which is of convex design.

As can be discerned in FIG. 1, by virtue of the structure, elucidated above, of end 18 of the pig body 12 a circumferential sealing lip 38 is formed which extends coaxially relative to the longitudinal axis 14 of the pig body 12.

At the end 20 situated opposite end 18 the pig body 12 exhibits a recess 40 which in the unstressed state is hemispherical. Said recess is arranged in centred manner relative to the longitudinal axis 14 of the pig body 12 and is dimensioned in such a way that a narrow annular surface 42 remains between it and the inner edge of the chamfer 24. This annular surface 42 extends, like the annular surface 32 at end 18, perpendicularly and coaxially relative to the longitudinal axis 14 of the pig body 12. In this way, at end 20 of the pig body 12 a second circumferential sealing lip 44 is formed which, like sealing lip 38, extends coaxially relative to the longitudinal axis 14 of the pig body 12.

The sealing lips 38 and 44 are spaced from one another in the direction of the longitudinal axis 14 of the pig body 12 and exhibit a radially outer sealing edge 46 and 48, respectively, which in each instance is formed by the radially outer edge of the chamfer 22 and 24, respectively.

The pig 10 includes a permanent magnet 50 which is provided inside the pig body 12, is magnetised in the direction of the longitudinal axis 14 of the pig body 12, and is arranged coaxially therewith. The permanent magnet 50 serves in known manner to be able to detect the position of the pig 10 within a system of pipes by means of suitable sensors which are known as such.

The pig body 12 is manufactured from an elastomeric material with a degree of hardness from 65 to 100 Shore D, preferably 85 Shore D. Hydrogenated nitrile rubber (HNBR), for example, enters into consideration as material for this purpose. An alternative consists in the use of vulcanisable fluoroelastomers based on vinylidene-fluoride/hexafluoropropylene copolymers. Other elastomeric materials also enter into consideration.

In order to ensure a simple integration of the permanent magnet 50 into the pig body 12 in the course of production of the pig 10, the pig body 12 is of bipartite design. Each part 52 and 54, respectively (cf. FIG. 1), can be produced by turning. The parts 52 and 54 can then, for example, be adhesion-bonded to one another after insertion of the permanent magnet 50, this being represented in FIG. 1 by the adhesive surface 56 indicated by a dotted line.

In an alternative exemplary embodiment, not represented here, on the side of the hemispherical recess 40 the pig 10 exhibits a closable blind bore which receives the permanent magnet 50 and which is accessible from the outside. This blind bore is closed with a stopper which is inserted into the blind bore in exactly fitting manner or adhesion-bonded therein. The stopper is manufactured from the same material as the pig 10 or the pig body 12.

FIG. 2 shows schematically a pig station 58, known as such, with an interior 60 in which two pigs 10 and 10′ are seated. The pigs 10 and 10′ are dimensioned in such a manner that their sealing edges 46, 48 and 46′, 48′, respectively, bear against the inner wall of the interior 60, even when the pigs 10, 10 are not being moved. The two pigs 10, 10′ are arranged in such a way that their projections 34 and 34′, respectively, are situated opposite one another. Into the interspace 62 formed in such a way between the pigs 10 and 10′ there leads a feed line 64 which is optionally capable of being closed and capable of being cleared by a valve, not represented here in any detail.

If a defined amount of a working medium, for example a lacquer, is now conveyed into the interspace 62 in known manner via the feed line 64, pig 10′ moves away from pig 10, for which purpose the latter is firstly fixed in its position. This can be effected, for example, by pig 10 having compressed air under sufficient pressure applied to it at its end 20. Alternatively, a conventional mechanical stop, not represented here, may also be provided at end 20 of pig 10.

Once the desired amount of lacquer has been charged, a lacquer packet is located between the two pigs 10 und 10′. The valve in the pig station 58 is closed, and the lacquer packet 66 between the two pigs 10 and 10′ is, as shown in FIG. 3, propelled into a supply line 68 by pig 10 having compressed air, which serves as thrust medium, applied at its end 20. The compressed air is indicated in FIG. 3 by the arrows 70.

The interior 60 of the pig station 58 in FIG. 2 is connected to the supply line 68 in aligned manner and itself serves as part of the supply line.

A force is exerted on end 20 of pig 10 by the compressed air 70. On the one hand, this force provides for the propulsion of pig 10. Over and above this, the compressed air 70 exerts a force on a surface of application of sealing lip 44. This surface of application is formed from the surfaces of the chamfer 24, of the annular surface 42, and of an end region 72 of the hemispherical recess 40. The force exerted on the surface of application 24, 42, 72 of sealing lip 44 by the compressed air 70 causes sealing lip 44 of the pig 10 to be pressed outwards, this being indicated in FIG. 1 by the position of sealing lip 44 represented by dashed lines, and in FIG. 3 by the curved arrows 74. In this way, sealing edge 48 of pig 10 is pressed against the inner wall 76 of the supply line 68.

In the course of the propulsion of the lacquer packet 66 a force is likewise exerted on end 18 of pig 10 situated opposite end 20. This force results from the resistance of the lacquer packet 66 and of the second pig 10′, which these offer to the propulsive force. In the process, a force is also exerted on a surface of application of sealing lip 38 of pig 10. The surface of application of sealing lip 38 is formed by the surfaces of the chamfer 22, of the annular surface 32 and also of the outer groove wall 30 of the annular groove 26. The force exerted on the surface of application 22, 32, 30 of sealing lip 38 causes sealing lip 38 of pig 10 to be pressed outwards, this being indicated in FIG. 1 by the position of sealing lip 38 represented by dashed lines, and in FIG. 3 by the curved arrows 78. Consequently, sealing edge 46 on sealing lip 38 of pig 10 is pressed against the inner wall 76 of the supply line 68.

No force is exerted on the surface of application 24′, 42′, 72′ of the sealing lip 44′ of the second pig 10′ in the course of the propulsion of the same within the supply line 68, as represented in FIG. 3. However, a sealing effect between the sealing edge 48′ of the sealing lip 44′ and the inner wall 76 of the supply line 68 occurs by virtue of the fact that the sealing edge 48′ bears against the inner wall 76 and the sealing lip 44′ is pressed by frictional forces in the direction towards the inner wall 76 of the supply line 68.

The surface of application 24, 42, 72 of sealing lip 44 is larger overall than the surface of application 22, 32, 30 of sealing lip 38. This causes sealing lip 44 to be pressed with a greater force against the inner wall 74 of the supply line 68 than is the case for sealing lip 38 of pig 10 if the same force is exerted on both sealing lips 38, 44. By this means, sealing lip 44 of pig 10 achieves a greater sealing effect relative to sealing lip 38. The sealing effect of pig 10 is consequently greater overall in the course of propulsion of the same within the supply line 68 than in the case of a pig with sealing lips of identical construction.

At the same time, a desired effect is preserved: if the pigs 10 and 10′ again come into a position as shown in FIG. 2, lacquer residues are mostly located in the interspace 62 between the pigs 10 and 10′. On account of these lacquer residues, pigs with flat ends are able to stick together in such a manner that they have to be separated from one another manually, in order to be capable of being employed again.

By virtue of the convex design of the free end face 36 and 36′, respectively, of the circular cylindrical projection 34 and 34′, respectively, of the pigs 10 and 10′, the risk of the two pigs 10 and 10′ sticking together by virtue of the lacquer is reduced, since they touch each other merely in punctiform manner. The interspace 62 can be freed of lacquer residues efficiently by injection of a cleaning agent.

Although it is preferred that the pig 10 has compressed air applied to it at its end 20 for the purpose of propulsion, and that the pig 10 is used unidirectionally, the pig 10 can certainly also be used bidirectionally; this means that it can also have compressed air applied to it from end 18, in order to propel it within a supply line.

1. A pig for conveying a working medium within a supply line, with
a) a pig body which is capable of being driven within the supply line by a thrust medium and which exhibits at one end a projection with a free end face;
b) at least one first and one second circumferential sealing element made of elastomeric material and arranged on the pig body, which are spaced from one another in the direction of the longitudinal axis of the pig body and extend coaxially relative to the longitudinal axis of the pig body;
wherein
c) the sealing elements are capable of being pressed against the inner wall of the supply line, by the working medium or the thrust medium exerting a force against a surface of application of the respective sealing element,
and further wherein,
d) the surface of application of the sealing element that is adjacent to the end with the projection is smaller than the surface of application of the other sealing element.

2. The pig of claim 1, wherein the first sealing element and the second sealing element take the form of first and second sealing lips with a radial outer sealing edge.

3. The pig of claim 1, wherein the pig body is formed from elastomeric material.

4. The pig of claim 1, wherein the elastomeric material is a hydrogenated nitrile rubber.

5. The pig of claim 1, wherein the elastomeric material is a fluoroelastomer based on vinylidene-fluoride/hexafluoropropylene copolymers.

6. The pig of claim 1, wherein the elastomeric material exhibits a hardness of substantially 65 to 100 Shore D.

7. The pig claim 6, wherein the elastomeric material exhibits a hardness of substantially 85 Shore D.

8. The pig of claim 1, wherein the free end face of the projection of the pig body is of convex design.

9. The pig of claim 1, wherein at the end with the projection the pig body exhibits an annular groove extending coaxially relative to the longitudinal axis of the pig body.

10. The pig of claim 1, wherein at the end situated opposite the end with the projection the pig body exhibits a recess that is arranged centrally relative to the longitudinal axis of the pig body.

11. The pig of claim 10, wherein the recess is hemispherical in the undeformed state.

12. The pig of claim 1, wherein the pig body is formed from a first part and from a second part, connected thereto, and contains a permanent magnet.

13. The pig of claim 1, wherein the pig body exhibits a closable blind bore which receives a permanent magnet.

14. The pig of claim 13, wherein the blind bore is closed by a stopper which is inserted into the blind bore in exactly fitting manner or is adhesion-bonded therein, the stopper being manufactured from the same material as the pig body.

15. The pig of claim 14 wherein the blind bore is provided on the side of the recess.

16. The pig of claim 13 wherein the blind bore is provided on the side of the recess.
